(19) United States
(12) Patent Application Publication
(10) Pub. No.: US 2013/0347097 A1
(43) Pub. Date: Dec. 26, 2013

(54) IMAGE PROCESSING APPARATUS, IMAGE PROCESSING METHOD, AND NON-TRANSITORY COMPUTER READABLE STORAGE MEDIUM

(71) Applicant: CANON KABUSHIKI KAISHA, Tokyo (JP)

(72) Inventor: Suyuan Pan, Suzhou (CN)

(21) Appl. No.: 13/921,480

(22) Filed: Jun. 19, 2013

(30) Foreign Application Priority Data
Jun. 26, 2012 (JP) 2012-143069

(51) Int. Cl. G06F 21/31

(52) U.S. Cl. CPC G06F 21/31
USPC 726/17

(57) ABSTRACT

In an image forming apparatus, in a case where a screen of an application requiring user authentication is continuously displayed, there has been a problem that operability is low for a user who does not log in. In a case where a screen of an authentication application is displayed, and the user does not perform user authentication, processing of the user authentication of the application is skipped.

### BACKGROUND OF THE INVENTION

1. Field of the Invention

The present invention relates to an image processing apparatus, an image processing method, and a program. Specifically, the present invention relates to an image processing apparatus, an image processing method, and a program that control screen transition between applications, and login/logout.

2. Description of the Related Art

Conventionally, a technology has been known that stores authority information and restriction information of a user for use of an application, refers to the stored authority information in a case where user authentication is successful, and displays a screen of an application available for an authenticated user (for example, refer to Japanese Patent Laid-Open No. 2009-232219).

In addition, there is known an image processing apparatus having an operation panel that displays a screen of an application in full screen, allows a user to switch the application only through a hardkey, and displays applications in order in accordance with previously set display order.

In the image processing apparatus as described above, in a case where user authentication is performed for each application, a system administrator may sometimes set a continuously displayed plurality of applications so as to require user authentication. In addition, the system administrator may sometimes set an application, which is displayed after an application set so as to require user authentication, so as not to require user authentication. In a case where such settings are made, and the user want to use an application not requiring authentication from a user unauthenticated state, there has been a problem that a same screen of an authentication application is displayed a plurality of times until the application not requiring authentication is displayed, thus confusing the user.

### SUMMARY OF THE INVENTION

An image processing apparatus pertaining to the present invention is the image processing apparatus in which order of displaying respective screens of a plurality of applications on a display component is set, and which is set so as to perform user authentication in a case of starting a predetermined application, and the image processing apparatus includes a control unit configured to skip processing of user authentication to display a screen of a second application on the display component based on an instruction received from a user, and the set order, in a case of starting a first application set so as to perform the user authentication.

According to the present invention, can be provided an image processing apparatus, an image processing method, and a program that achieve screen transition control and authentication control with high operability.

Further features of the present invention will become apparent from the following description of exemplary embodiments (with reference to the attached drawings).

### BRIEF DESCRIPTION OF THE DRAWINGS

FIG. 1 is a system configuration diagram in one embodiment of the present invention;

FIG. 2 is a block diagram showing a hardware configuration of an image processing apparatus;

FIG. 3 is a block diagram showing a software configuration of the image processing apparatus;

FIG. 4 is a view showing an example of a screen for managing an application;

FIG. 5 is a view showing an example of a screen on which display order, authentication validity, etc. of the application are set;

FIG. 6 is a block diagram showing a configuration of schematic functions of an application display manager;

FIG. 7 is a diagram showing an example of an adjustment method of application display order;

FIG. 8 is a diagram showing an example of an operation panel of the image processing apparatus;

FIG. 9 is a view showing an example of screen transition in a case where authentication is not performed on all applications;

FIG. 10 is a view showing an example of screen transition in a case where authentication is performed on applications;

FIG. 11 is a flow chart showing control for screen transition of the applications;

FIG. 12 is a flow chart showing control of behavior of an authentication application at the time of login;

FIG. 13 is a flow chart showing control of behavior of the authentication application at the time of logout;

FIG. 14 is a diagram showing an example of transition to a presentation screen displayed while an authentication screen is displayed;

FIG. 15 is a diagram showing the relationship of FIGS. 15A, 15B, and 15C; and

FIGS. 15A to 15C are a flow chart showing control of screen transition of the application including the presentation screen.

### DESCRIPTION OF THE EMBODIMENTS

Hereinafter, modes for carrying out the present invention will be described using drawings. However, components set forth in this embodiment are just exemplifications, and it is not intended to limit the scope of the invention to them.

### First Embodiment

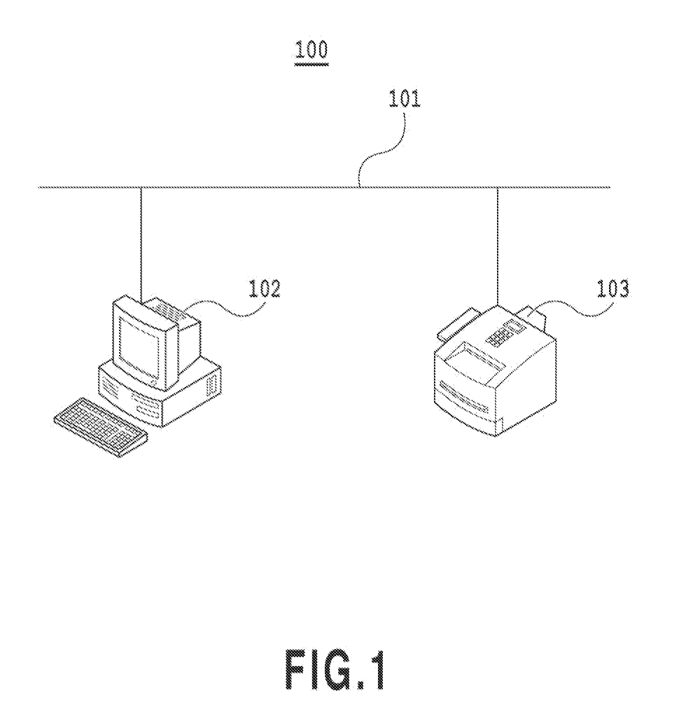

FIG. 1 is a diagram showing a configuration of a system in which an image processing apparatus pertaining to one embodiment of the present invention is utilized. A system 100 includes a setting PC (personal computer) 102 and an image forming apparatus 103 that are connected on a network 101. In this system 100, a system administrator can manage access restriction of a user who utilizes functions of the image forming apparatus 103 and an application installed in the image forming apparatus 103. It is to be noted that in the present embodiment, user access restriction can be managed for each individual user, and for each organization, such as a department to which the user belongs. A utility software for the system administrator is installed in the setting PC 102. The system administrator uses the utility software of the setting PC 102 to manage setting of the system 100. Particularly, the system administrator uses this utility software in order to perform installation of applications on the image forming apparatus 103, setting of order of the applications displayed on the image forming apparatus 103, and setting of necessity of authentication for using the applications. Details of installation and various settings of the applications that are performed through the setting PC 102 will be described later.

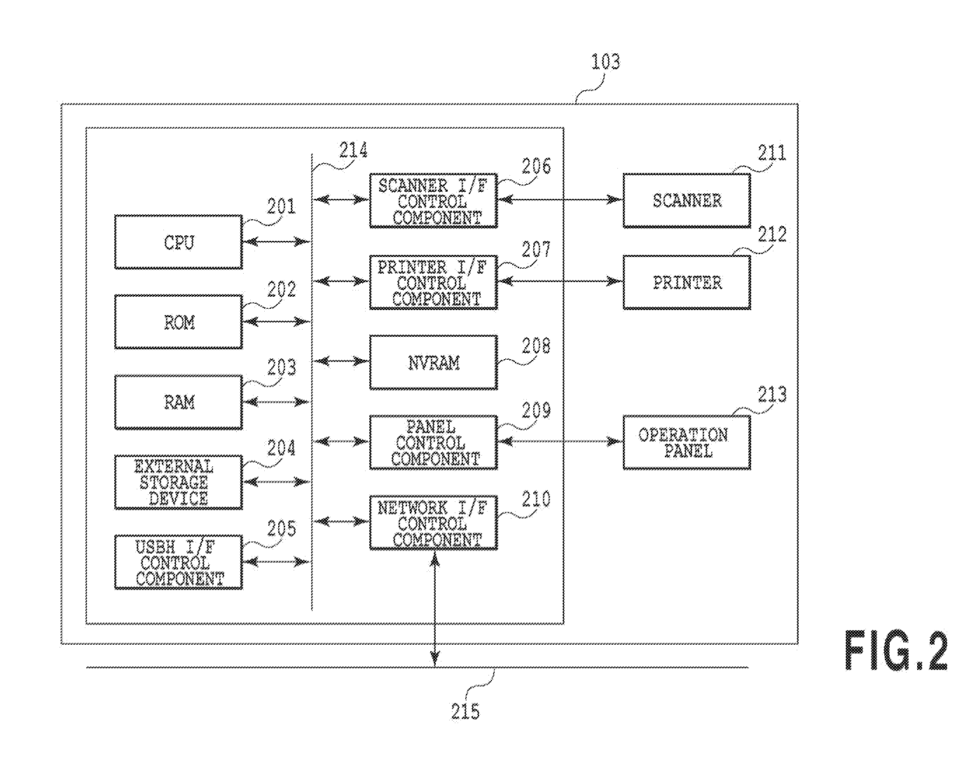

FIG. 2 is a block diagram showing a hardware configuration of the image forming apparatus 103 in FIG. 1. It is to be noted that although the image forming apparatus is described as an example in the present embodiment, the present invention is not limited to this. The present invention can be achieved also in another apparatus having functions to perform screen transition and user authentication for operation, and for example, the image forming apparatus 103 may be an image processing apparatus, an information processing apparatus, etc.

A CPU 201 expands and executes a software program stored in a storage component, such as a ROM 202, a RAM 203 of the image forming apparatus, or an external storage device 204, and controls behavior of the whole apparatus. The ROM 202 is a read only memory, and stores a boot program, a fixed parameter, etc. of the apparatus. The RAM 203 is a random access memory, and is used for storing temporary data, etc. in a case where the CPU 201 controls the behavior of the apparatus. The external storage device 204 is used for storing various data, such as an installed application, application data, and print data. A USBH I/F control component 205 is an interface for controlling a USB host interface, and controls communication with various USB devices. A scanner I/F control component 206 is a device that controls a scanner 211. A printer I/F control component 207 is a device that controls a printer 212. An NVRAM 208 is a nonvolatile memory, and stores various set values of the image forming apparatus 103. A panel control component 209 is a control component for controlling an operation panel 213 to display various information and receive an input from the user. A network I/F control component 210 controls transmission and reception of data through a LAN network 215. To a bus 214, connected are: the CPU 201; ROM 202; RAM 203; external storage device 204; USBH I/F 205; scanner I/F control component 206; printer I/F control component 207; NVRAM 208; panel control component 209; and network I/F control component 210. In addition, the bus 214 is a system bus through which a control signal from the CPU 201 and a data signal between the respective devices are transmitted and received. The scanner 211 is a device that reads image information appeared on manuscripts, such as a paper document. The printer 212 is a device that prints image information. The operation panel 213 is a device that displays a user interface to the user in accordance with a command of the panel control component 209, receives an input instruction of the user, and passes it to the panel control component 209.

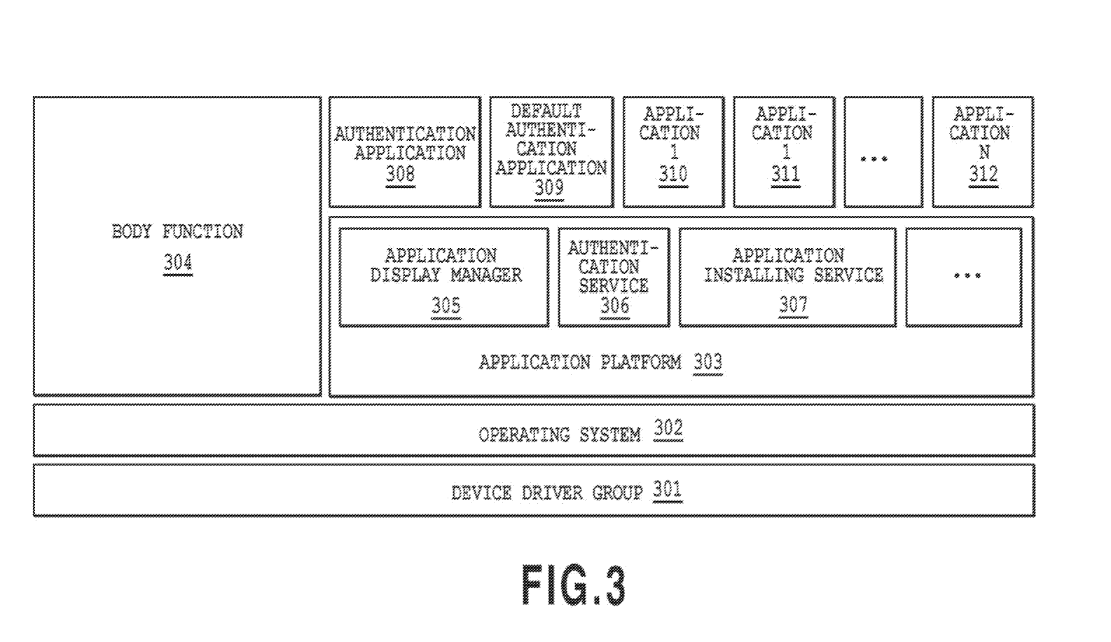

FIG. 3 is a diagram showing a software configuration of the image forming apparatus 103. A device driver group 301 is a module group for providing an operating system 302 with a digital interface for utilizing a function of each hardware device shown in FIG. 2. The operating system 302 is system software for providing a body function 304 and an application platform 303 with an interface that abstracts hardware. The body function 304 is a default function that the image forming apparatus 103 has, such as printing and copying. The application platform 303 is system software that provides the application with a part of functions that the operating system 302 provides in a form of service or a library, and manages the installed application.

Application installing service 307 is system software that provides functions to manage an application (installation, uninstallation, and system setting relevant to the application, etc.) in the application platform 303.

An application display manager 305 is also one of system softwares that provides system service in the application platform. 303. The application display manager 305 manages display of an application displayed on the operation panel 213 of the device according to a content set by the application installing service 307.

Authentication service 306 is system software that provides a function of user authentication. The authentication service 306 exports an authentication interface to an authentication application 308 or a default authentication application 309. The authentication service 306 receives an authentication request from the authentication application 308 or the default authentication application 309, and issues or clears a login context. The login context is a unit configured to manage information on authority of an authenticated user, etc. An application that uses user information acquires information of the authenticated user from the login context.

In addition, a plurality of applications as shown in reference numerals 308 to 312 is installed in the image forming apparatus 103.

The authentication application 308 is a particular application for performing user authentication by a method customized according to a request (for example, dealing with IC card coordinated authentication, etc.) from the user. The authentication application 308 is implemented with an interface according to a specification of the authentication service 306.

The default authentication application 309 is a system application for performing user authentication as an initial authentication function of the application platform 303 utilizing the operation panel 213.

The default authentication application 309 and the customized authentication application 308 cannot behave simultaneously, and one of them can behave only while the other thereof is not behaving. Switching of the authentication application to the default authentication application 309 or the authentication application 308 is performed through a setting page displayed on the setting PC 102. Details of a switching method will be described later.

An application 1 310 to an application N 312 are an application group that is implemented utilizing an interface of the application platform 303, and provides various functions. The application 1 310 to the application N 312 are installed through the application installing service 307.

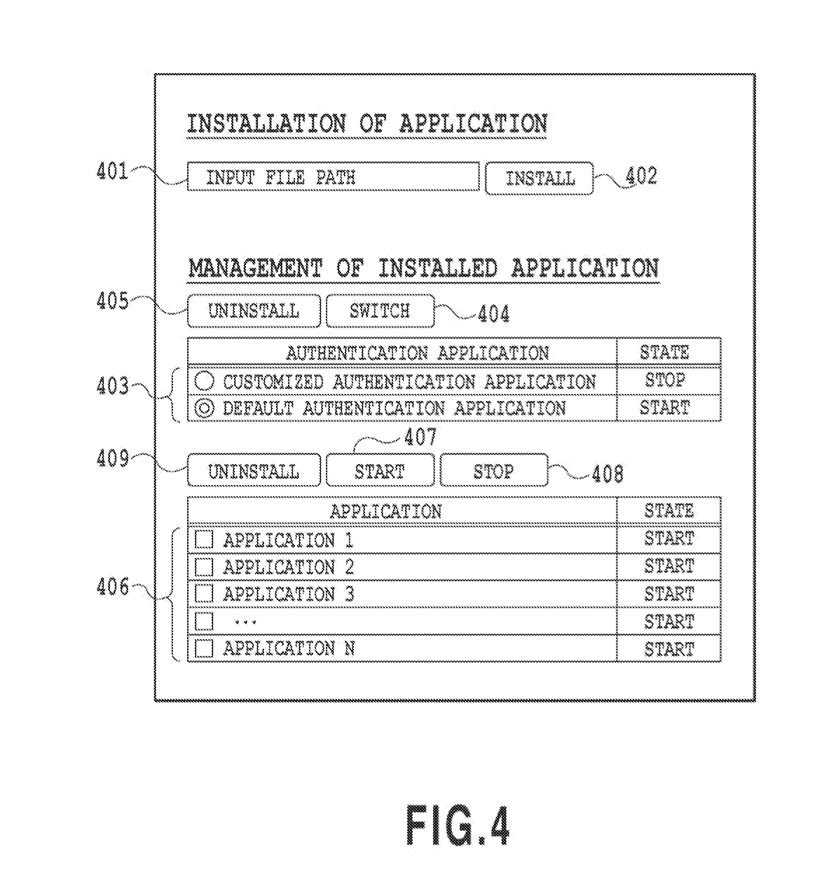

FIG. 4 shows a web page as one example of an operation screen for utilizing functions that the application installing service 307 provides. In the present embodiment, the system administrator can perform installation, uninstallation, etc. of an application utilizing the web page. The system administrator can operate the setting PC 102 to display the web page on the display component through a web browser.

An input field 401 is a field for inputting a file path of an installation target application stored in setting PC 102 or the apparatus on the network.

An install button 402 is a button for installing in the image forming apparatus 103 the application of the file that exists in the path input into the input field. Upon pressing of the install button 402 by the user, the image forming apparatus 103 receives a file for installing an application via the network. The application installing service 307 installs the application in the application platform 303 using the received file.

An authentication application table 403 is a table for indicating an installed authentication application and a start-up state of the authentication application.

A switch button 404 is a button for starting the authentication application selected in the authentication application table 403 in the image forming apparatus 103. For example, in a case where a “default authentication application” of the authentication application table 403 is in a start-up state, upon selecting a “customized authentication application” and pressing the switch button 404, a “customized authentication application” enters a start-up state.

An uninstall button 405 is a button for uninstalling the authentication application selected within the authentication application table 403 from the image forming apparatus 103.

An application table 406 is a table for indicating general applications other than the authentication application of the applications installed in the image forming apparatus 103, and start-up states of these general applications.

A start button 407 is a button for starting the application selected in the application table 406 in the image forming apparatus 103.

A stop button 408 is a button for stopping the application selected in the application table 406.

Uninstall 409 is a button for deleting the application selected in the application table 406 from the image forming apparatus 103.

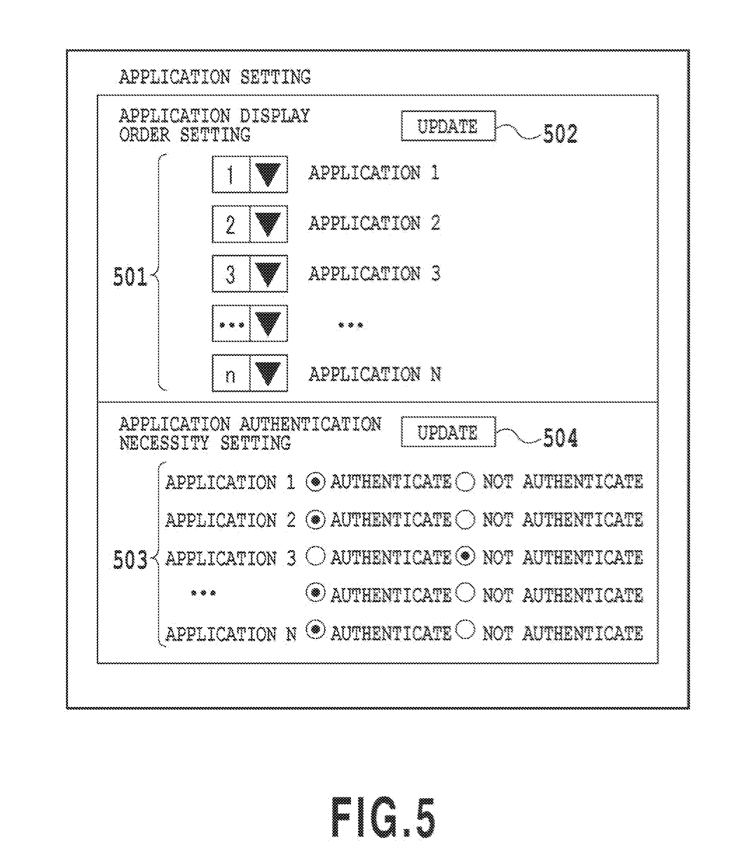

FIG. 5 shows a web page as one example of an operation screen for utilizing functions that the application installing service 307 provides. In the present embodiment, the system administrator can utilize this web page to perform adjustment of display order of the applications displayed on the operation panel 213, and setting of authentication necessity of the applications. The system administrator can operate the setting PC 102 to display the web page on the display component through the web browser.

An application display order list 501 indicates display order of current set applications. In addition, the system administrator can adjust the display order of the applications through the application display order list 501.

An application display order update button 502 is a button for reflecting updated order in the image forming apparatus 103, after the display order of the applications is adjusted in the application display order list 501.

An application authentication list 503 indicates a setting of whether or not user authentication is required for each application in a case of starting use of the application. In addition, the system administrator can set to each application whether to perform user authentication through the application authentication list 503.

An authentication setting update button 504 is a button for reflecting an updated setting in the image forming apparatus 103, after setting is performed in the application authentication list 503.

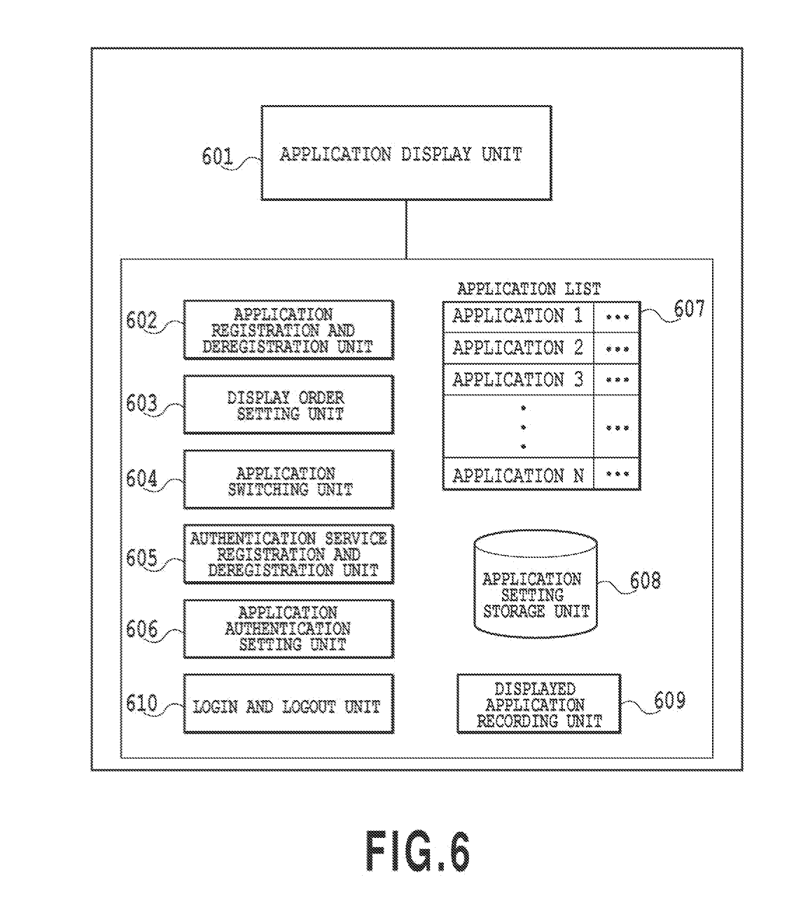

FIG. 6 is a block diagram showing a schematic functional configuration of the application display manager 305 in the present embodiment.

An application display unit 601 is a unit configured to display a user interface of an application, such as an authentication application and a general application, on the operation panel 213 in full screen.

An application registration and deregistration unit 602 is a unit configured to register in the application display manager 305 the application installed in the image forming apparatus 103 as a display target application, or to deregister the application. A screen of the application registered by the application registration and deregistration unit 602 is displayed on the operation panel 213 by the application display unit 601. In a case where the user presses the above-described start button 407, and the application enters a start-up state, the application is registered in the application display manager 305. In a case where the user presses the stop button 408, and the application enters a stop state, the application is deregistered.

In a case where the user adjusts order of the applications using the application display order list 501, a display order setting unit 603 receives a notice of information of the adjusted order from the application installing service 307. After receiving the notice of the information of the adjusted order from the application installing service 307, the display order setting unit 603 changes the display order of the applications stored in an application list 607 according to a content of the notice.

An application switching unit 604 is a unit configured to switch an application of a screen displayed on the operation panel 213 according to an instruction from the user through the operation panel 213. Switching of the screen of the application to be displayed is performed through the application display unit 601 according to the display order of the applications stored in the application list 607.

An authentication service registration and deregistration unit 605 is a unit configured to perform registration and deregistration of the authentication application used for user authentication. Upon pressing of the switch button 404 by the user, the authentication service registration and deregistration unit 605 receives an instruction of switching the authentication application from the application installing service 307, and registers or deregisters the authentication application according to the instruction. In a case where the authentication application is registered, a user interface of the authentication application is registered as a screen displayed at the time of user authentication. In a case where the authentication application is deregistered, the user interface of the authentication application is deregistered.

An application authentication setting unit 606 is a unit configured to set whether or not user authentication is required for each application in a case of starting use of the application. In a case where the user requests setting of necessity of authentication with respect to the application through the application authentication list 503, the application authentication setting unit 606 receives the request of the setting from the application installing service 307, and performs setting according to a content of the request. The application display manager 305 receives a request of application authentication validity setting of the application installing service 307, and overwrites authentication setting information of each application stored in the application list 607.

The application list 607 is a list of information of registered applications, setting information of the applications (including authentication setting information of the applications), and information of display order of the applications, and it is stored on a memory.

An application setting storage unit 608 is a unit configured to store the information of the application list 607 in the external storage device 204. In a case where the application list 607 is updated, the application setting storage unit 608 stores updated information of the application list 607 in the external storage device 204.

A displayed application recording unit 609 is a unit configured to record information of the application displayed on the operation panel 213 by user operation.

A login and logout unit 610 is a unit configured to switch between display of a screen of the authentication application and display of a screen of a general application in order that the user performs user authentication to log in the application, or log out of the application. The login and logout unit 610 switches display of the screen according to a request from the authentication service 306.

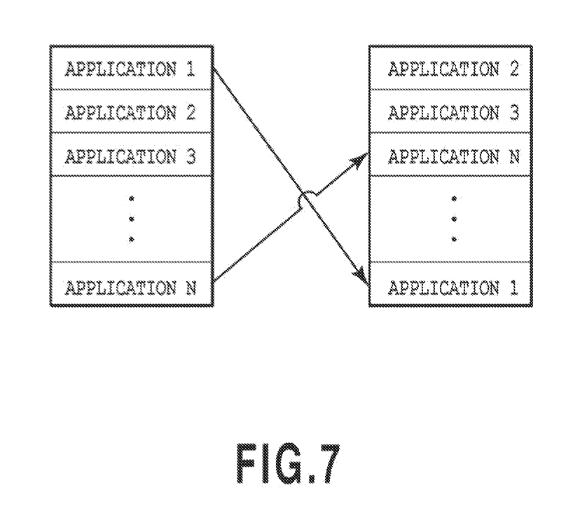

FIG. 7 is a diagram showing an example of adjustment of display order of screens of applications. In a case where the user instructs to move display order of an application 1 from the first to the n-th, and display order of an application n from the n-th to the third through the screen as shown in FIG. 5, the application display manager 305 changes display order of the screens of the application 1 and the application n to instructed order. In addition, the application display manager 305 changes order of an application 2 to the first, and order of an application 3 to the second.

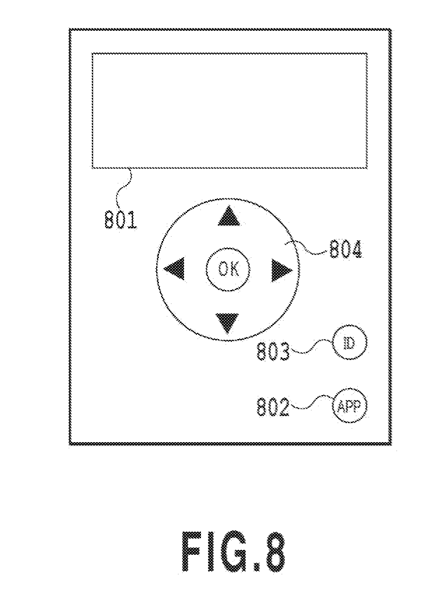

FIG. 8 shows an example of the operation panel 213 of the device. A screen 801 is a screen for displaying a screen of an application. The screen 801 displays a screen according to a command from the application display unit 601.

An application switching key 802 is a key for the user to instruct switching of display of the screen of the application. Upon pressing of the application switching key 802, the application switching unit 604 of the application display manager 305 switches display of the application.

A login and logout key 803 is a key for the user to perform user authentication to instruct log in, or log out of the application. Upon pressing of the login and logout key 803 by the user, the screen of the authentication application and the screen of the general application are switched.

A general-purpose “OK” key 804 is a key widely used for operation of the image forming apparatus 103 by the user. For example, in a case where the user confirms or approves a content displayed on the screen 801, the general-purpose “OK” key 804 is pressed by the user. Upon pressing of the general-purpose “OK” key 804, the image forming apparatus 103 performs predetermined behavior, such as switching of the screen displayed on the screen 801.

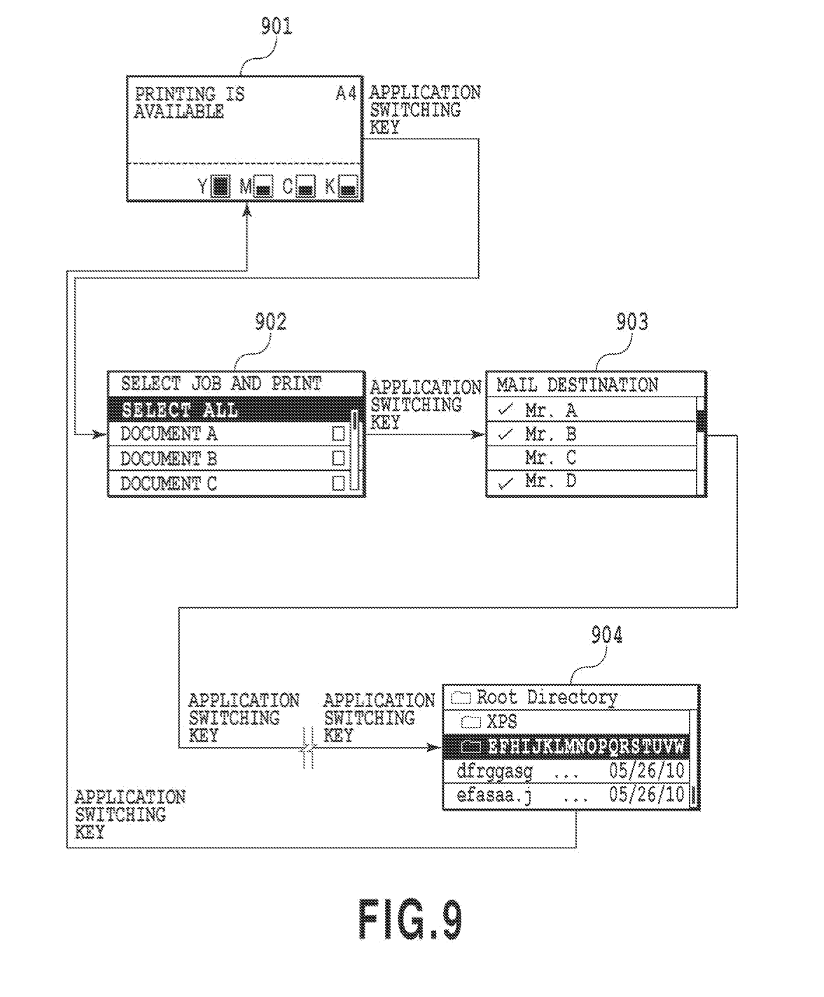

FIG. 9 shows a sequence of screen transition in a case where user authentication is not performed on any applications registered by the application registration and deregistration unit 602.

A system top screen 901 is a top screen of the body function 304 displayed on the operation panel 213, and is a screen that displays a state of a system of the image forming apparatus 103. Upon pressing of the application switching key 802 during the display of the system top screen 901, the application display manager 305 refers to display order information of the applications of the application list 607, and displays on the operation panel 213 a screen 902 of the application 1 whose display order is the first. The application display manager 305 records information of the application 1 as information of the application being displayed by the displayed application recording unit 609. Upon pressing of the application switching key 802 during the display of the application 1, the application display manager 305 displays on the operation panel 213 a screen 903 of the application 2 whose display order is the second in accordance with the display order information of the applications of the application list 607. The application display manager 305 records information of the application 2 as information of the application being displayed by the displayed application recording unit 609. Hereinafter, similarly, whenever the application switching key 802 is pressed, a screen of an application that should be displayed next to the currently displayed application is displayed on the operation panel 213 in accordance with the display order information of the applications of the application list 607.

A screen 904 of the application N is a screen displayed last in the display order of the applications recorded in the application list 607. Upon pressing of the application switching key 802 during the display of the screen 904 of the application N, the application display manager 305 determines that the screen 904 of the application N is a screen displayed last in accordance with the information of the application list 607, and displays the system top screen 901. The application display manager 305 records information of a system screen by the displayed application recording unit 609.

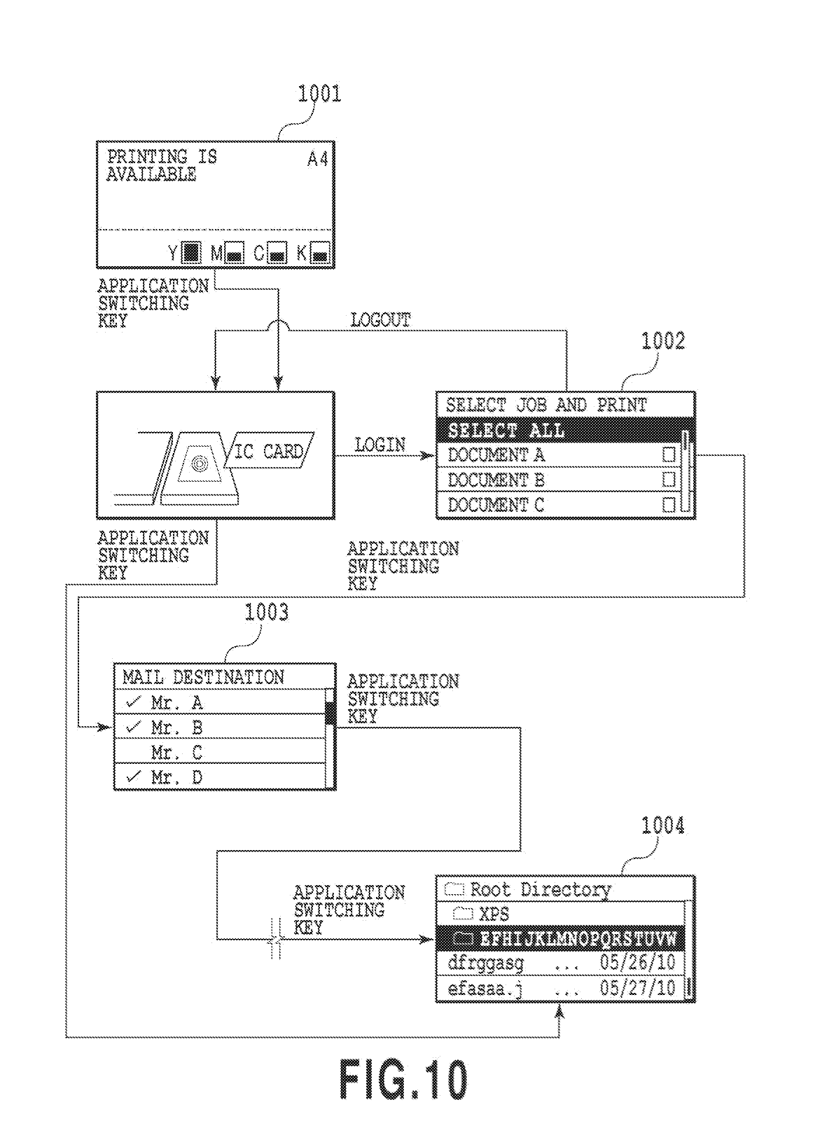

FIG. 10 shows an example of a sequence of screen transition in a case where it is set that user authentication is performed on a part of the applications registered by the application registration and deregistration unit 602, in starting use of the application.

In this example, user authentication is performed by the authentication application 308. The authentication application 308 is the authentication application in which an authentication method can be customized. The authentication application 308 utilizes the USBH I/F control component 205, controls an external IC card reader to read user information included in the IC card, checks read information with registered authentication information, and performs authentication processing.

In addition, in the following description of this example, it is assumed that user authentication is set to be required for all the applications whose display order is anterior to the application N.

First, the user presses the application switching key 802 while a system top screen 1001 is displayed. Next, the application display manager 305 refers to the application list 607, determines that user authentication is required in order to display the screen of the application 1, and displays a screen of the authentication application 308 on the operation panel 213. The application display manager 305 records information of the authentication application 308 as the information of the application currently being displayed by the displayed application recording unit 609. In a case where operation for user authentication is performed by the user, and user authentication is successful, the authentication service 306 issues a login context, and performs login behavior by the login and logout unit 610. The application display manager 305 records a login state, displays a screen 1002 of the application 1, and records the information of the application 1 by the displayed application recording unit 609.

Upon pressing of the login and logout key 803 during the display of the screen 1002 of the application 1, the authentication service 306 clears the above-described login context, and performs logout behavior by the login and logout unit 610. Next, the application display manager 305 records a logout state, displays the screen of the authentication application 308 on the operation panel 213, and records the information of the authentication application 308 by the displayed application recording unit 609.

Upon continuously pressing of the application switching key 802 during the display of a screen of an application requiring user authentication, the application display manager 305 displays screens of the applications in order in accordance with the display order of the applications of the application list 607. Here, upon pressing of the application switching key 802 without performing user authentication during the display of the screen of the authentication application 308, the application display manager 305 refers to authentication setting information of the applications and display order information of the applications of the application list 607. The application display manager 305 determines that all the applications specified to be displayed anterior to the application N require authentication in accordance with the referenced information, skips processing for authentication, and displays the screen of the application N. The application display manager 305 records information of the application N by the displayed application recording unit 609.

As described above, in the example shown in FIG. 10, upon pressing of the application switching key 802 before start of user authentication processing of an application, among applications whose display orders are specified posterior to the application, a screen of an application not requiring user authentication is displayed. Namely, in a case where a first application requiring user authentication is started, control is made such that processing of user authentication in the first application is skipped, and a screen of a second application is displayed, based on an instruction from the user and the display order information of the application list 607. This control is performed by the application display manager 305.

In detail, the screen of the second application can be made as a screen of an application in which display order is set to be displayed first after the screen of the first application was displayed among screens of applications in which user authentication is not set to be performed.

In addition, as a modified example, upon pressing of the application switching key 802, a screen of an application specified to be displayed next (or the screen of the authentication application for using the application) may be displayed regardless of the necessity of user authentication. Namely, the screen of the second application can be made as a screen of an application in which display order is set to be displayed next to the screen of the first application.

As a result of it, without performing authentication operation for using an application, the user can display a screen of an application that can be used posterior to the application. In addition, upon pressing of the application switching key 802, all the processing of user authentication in the applications requiring user authentication is skipped, and thereby operability in a case where the user wants to use the application not requiring user authentication is improved.

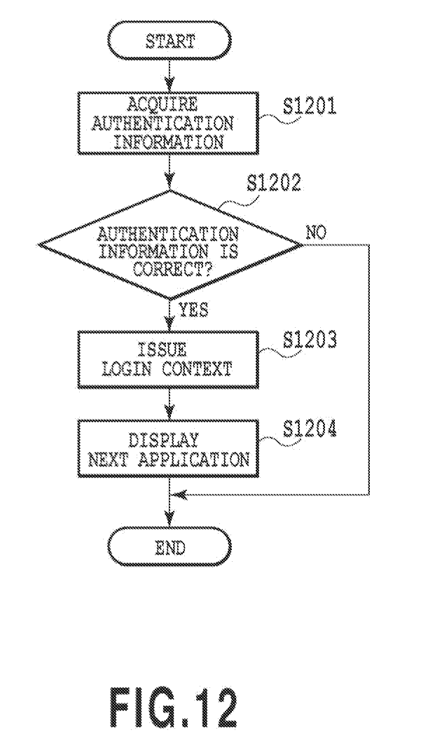

With reference to FIG. 12, there will be described a flow of processing by the image forming apparatus 103 executed in a case where the authentication application detects a request for starting user authentication processing. Control of the processing is performed by the CPU 201 expanding to the RAM 203 and executing a program stored in the ROM 202 and the external storage device 204. Control of processing shown in a flow chart that will be described hereinafter is similarly performed.

In S1201, in a case of detecting authentication operation (for example, holding an IC card over the external IC card reader) by the user, the authentication application 308 acquires authentication information according to the authentication operation.

Next, in S1202, the authentication application 308 checks the acquired authentication information with previously registered authentication information, and determines whether or not the acquired authentication information is correct. In a case where the authentication information is correct, the authentication application 308 makes the authentication service 306 issue a login context in S1203. Namely, in a case where user authentication is successful, the user is in a state of being logged in the application.

In S1204, the authentication application 308 makes the application display manager 305 perform login behavior by the login and logout unit 610, and records a login state. Next, the application display manager 305 refers to information of the display order of the application list 607 and record by the displayed application recording unit 609, and displays on the operation panel 213 a screen of an application whose display order is specified to be next. The application display manager 305 records information of the application on the displayed screen by the displayed application recording unit 609.

In S1202, in a case where it is determined that authentication information is not correct, the authentication application 308 ends processing, and displays the top screen of user authentication on the operation panel 213. It is to be noted that although here, a screen makes transition directly to an authentication top screen in order to simplify the description, the authentication application may display an authentication failure message.

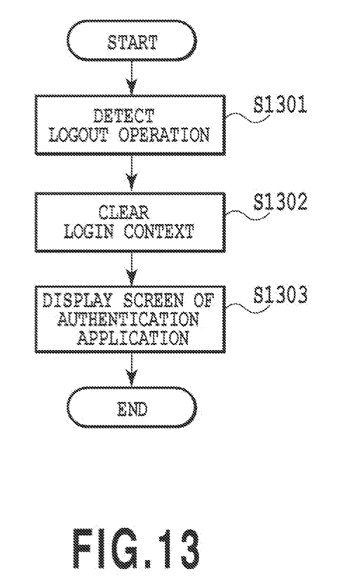

With reference to FIG. 13, there will be described a flow of processing for logging out from a login state into an application.

In S1301, upon pressing of the login and logout key 803 by the user, the authentication application 308 detects that logout operation has been performed by the user. Next, in S1302, the authentication application 308 makes the authentication service 306 clear an issued login context, and makes the application display manager 305 perform logout behavior by the login and logout unit 610. Subsequently, in S1303, the application display manager 305 records a logout state, displays a top screen of the authentication application 308 on the operation panel 213, and records the authentication application by the displayed application recording unit 609.

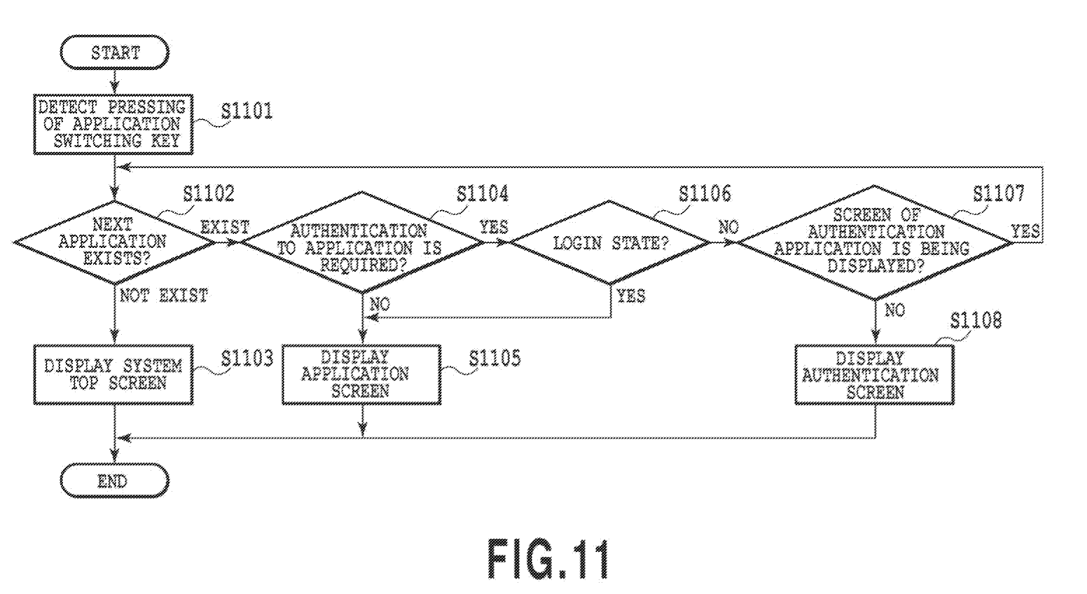

With reference to FIG. 11, there will be described a flow of processing in which the application display manager 305 controls screen transition.

First, in S1101, the application display manager 305 detects that the application switching key 802 has been pressed by the user. Next, in S1102, the application display manager 305 refers to the application list 607 and record by the displayed application recording unit 609, and determines whether or not a screen of an application specified to be displayed next to a displayed screen exists.

In a case where the screen of the application specified to be displayed next does not exist, in S1103, the application display manager 305 displays the system top screen, records information of the system screen by the displayed application recording unit 609, and ends processing.

In addition, in S1102, in a case where it is determined that the screen of the application specified to be displayed next exists, processing proceeds to S1104. In S1104, the application display manager 305 refers to the display order information and application authentication setting information of the application list 607, and determines whether or not the application of the screen specified to be displayed next requires user authentication. In a case where it is determined that the application does not require user authentication, processing proceeds to S1105. In S1105, the application display manager 305 displays the screen of the application specified to be displayed next, records information of the application on the displayed screen by the displayed application recording unit 609, and ends processing.

In addition, in S1104, in a case where it is determined that the application of the screen specified to be displayed next requires user authentication, processing proceeds to S1106. In S1106, the application display manager 305 refers to the authentication information recorded by the login and logout unit 610, and determines whether or not the user has been authenticated (i.e., has been logged in). In a case where it is determined that the user has already been authenticated, processing proceeds to S1105.

In S1106, in a case where it is determined that the user has not been authenticated yet, processing proceeds to S1107. In S1107, the application display manager 305 refers to the record by the displayed application recording unit 609, and determines whether or not the screen of the authentication application 308 is being displayed. In a case where the screen of the authentication application 308 is not being displayed, in S1108, the application display manager 305 displays the screen of the authentication application 308, records information of the authentication application by the displayed application recording unit 609, and ends processing.

In S1107, in a case where it is determined that the screen of the authentication application has been already displayed, information of an application displayed next is recorded by the displayed application recording unit 609, and processing proceeds to S1102.

Namely, in the processing of FIG. 11, in a case where the user is not in the login state, and the screen of the authentication application 308 is displayed (“NO” in S1106 or “YES” in S1107), it is determined whether or not the next application requires user authentication (“EXIST” in S1102 and S1104). In a case where the next application does not require user authentication (“NO” in S1104), the screen of the application is displayed (S1105). In a case where user authentication is required, processing proceeds to S1106 again.

As a result of it, upon pressing of the application switching key 802 before start of user authentication processing of the application, among the applications whose display orders are specified posterior to the application, the screen of the application not requiring user authentication is displayed. Namely, in the case where the first application requiring user authentication is started, control is made such that processing of user authentication in the first application is skipped, and the screen of the second application is displayed, based on the instruction from the user and the display order information of the application list 607.

According to the above processing, in a case where the applications set to require authentication are continuously aligned in the display order of the screens of the applications, repeated display of the authentication screen can be avoided. As a result of this, since an unauthenticated user can make the screen of the application not requiring authentication display by single operation, user operability can be improved.

### Second Embodiment

Hereinafter, a second embodiment of the present invention will be described with reference to the drawings. The second embodiment is an example where user operability during authentication screen display is improved based on the first embodiment. Since a system configuration, a hardware configuration, an application management screen, a setting screen, etc. of the second embodiment are similar to those of the first embodiment, description thereof will be omitted.

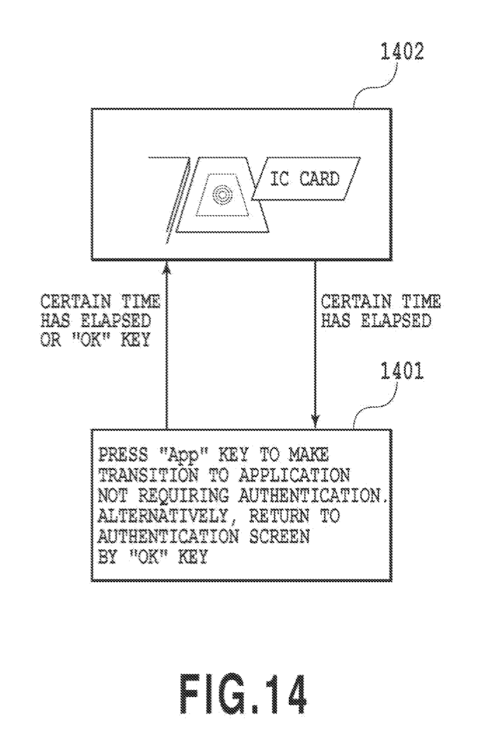

With reference to FIG. 14, there will be described control of processing in displaying a screen for presenting an operation method to the user, while the screen of the authentication application 308 in FIG. 10 is displayed.

A presentation screen 1401 is a screen that presents to the user operation for displaying the screen of the application not requiring authentication while the screen of the authentication application 308 is displayed. In a case where a certain time has elapsed after the screen of the authentication application 308 was displayed, the application display manager 305 displays the presentation screen 1401 on the operation panel 213. It is shown in the presentation screen 1401 that the user should press the application switching key 802, in a case where the user wants to make the screen transition to the screen of the application not requiring authentication. In addition, it is shown in the presentation screen 1401 that the user should press the general-purpose “OK” key 804, in a case where the user wants to display the screen of the authentication application 308. Namely, in a case where a certain time has elapsed after the screen of the application for user authentication was displayed on the display component, the application display manager 305 switches display of the display component to the presentation screen that presents the operation method for skipping processing of user authentication.

In a case where a certain time has elapsed after the presentation screen 1401 was displayed, or in a case where it is detected that the general-purpose “OK” key 804 has been pressed, the application display manager 305 displays the screen of the authentication application 308 on the operation panel 213.

Namely, in a case where a certain time has elapsed after the above-described presentation screen was displayed on the display component, or in a case where it is detected that the general-purpose “OK” key 804 has been pressed, the application display manager 305 switches display of the display component to the screen of the application for user authentication.

As described above, in a case where a certain time has elapsed after the screen of the authentication application was displayed, the screen is displayed that presents to the user the operation method for skipping processing of user authentication, and thereby operability of the image forming apparatus 103 is improved.

Even in a case where the user performs authentication operation (for example, the user's holding the IC card over the IC card reader) while the presentation screen 1401 is displayed, the application display manager 305 performs processing of authentication similarly while the screen of the authentication application 308 is displayed. In addition, in a case of detecting that the application switching key 802 has been pressed while the presentation screen 1401 is displayed, the application display manager 305 displays the screen of the application not requiring authentication.

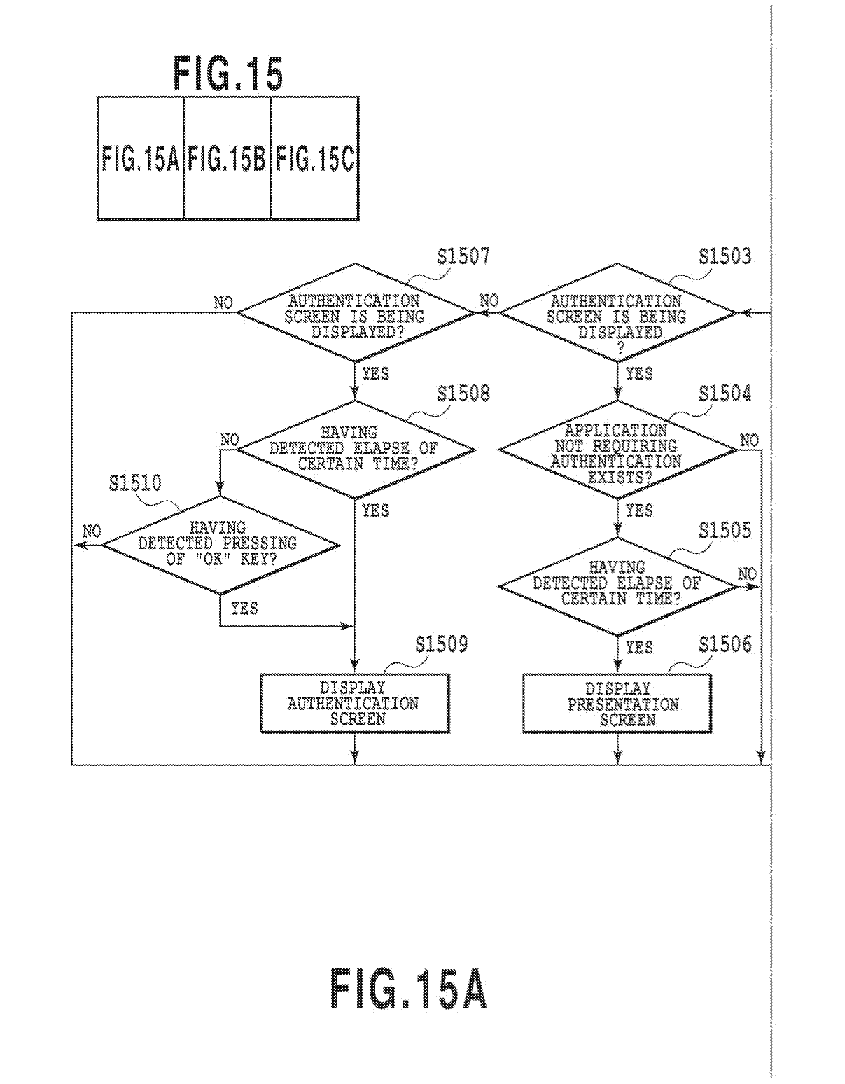

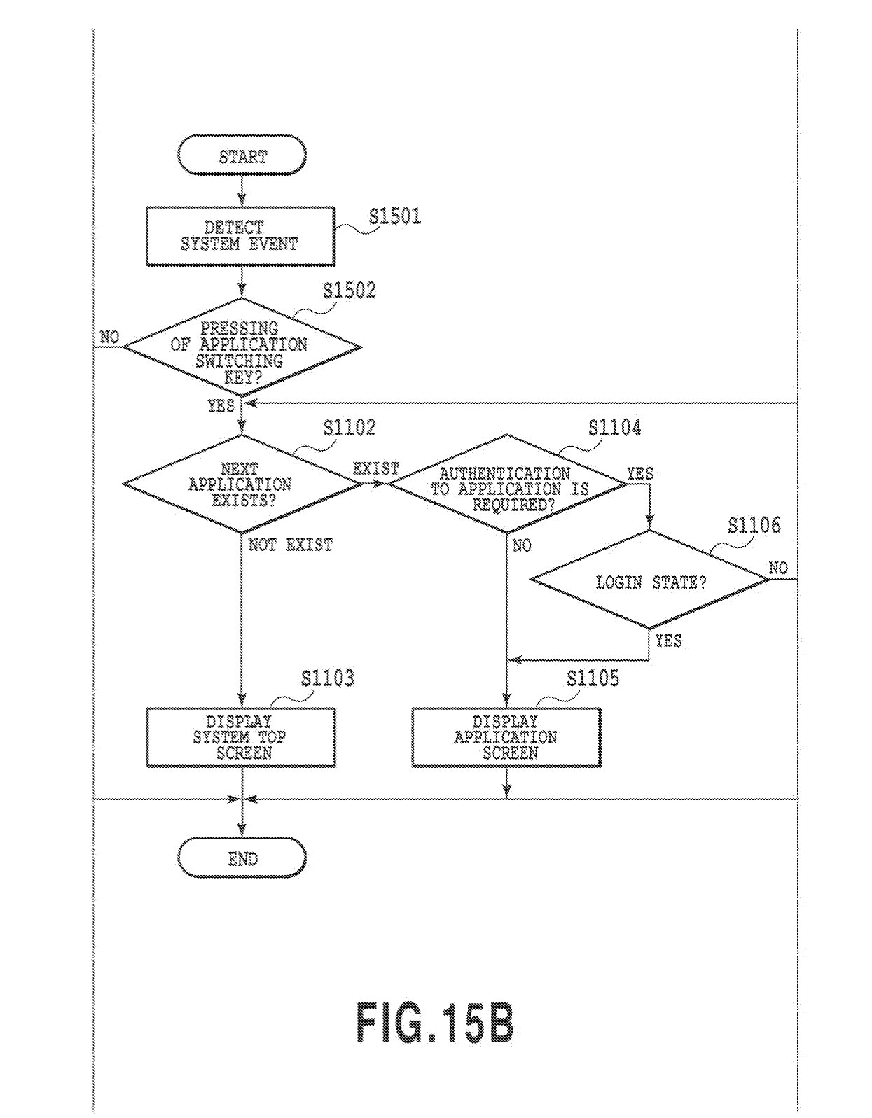

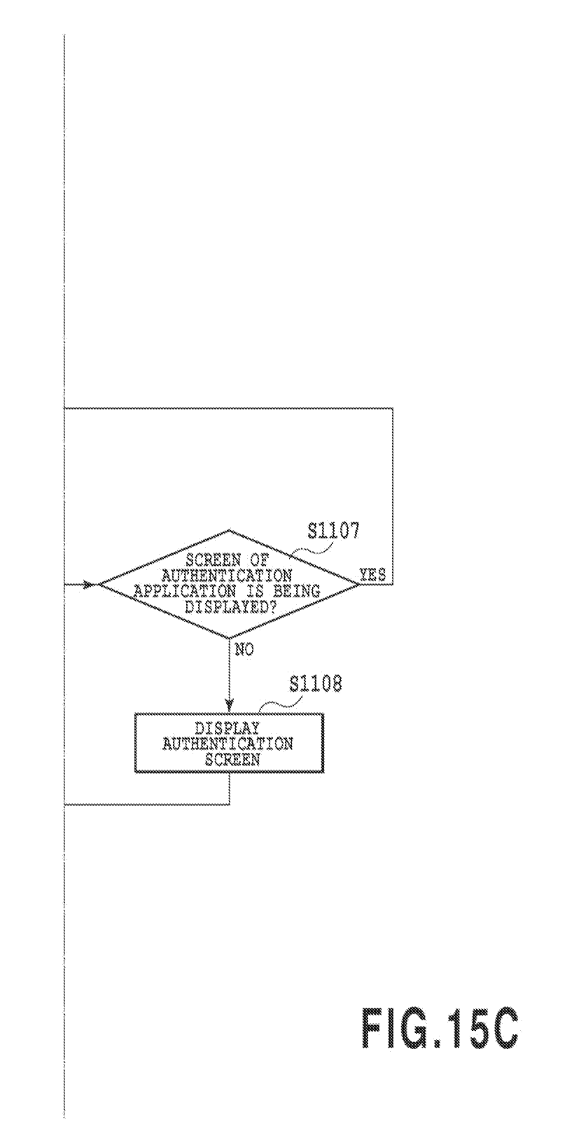

With reference to FIGS. 15A to 15C, there will be described a flow of processing in which the application display manager 305 controls transition of screens including the presentation screen 1401 in the present embodiment.

First, in S1501, the application display manager 305 detects a system event. Next, in S1502, the application display manager 305 determines whether or not the detected system event is pressing of the application switching key 802. In a case where the detected system event is the pressing of the application switching key 802, the application display manager 305 performs processing similar to the processing described with reference to FIG. 11, and thus description thereof is omitted here.

In a case where the detected system event is not the pressing of the application switching key 802, processing proceeds to S1503. In S1503, the application display manager 305 refers to the displayed application recording unit 609, and determines whether or not the screen of the authentication application 308 is currently displayed. In a case where it is determined that the screen of the authentication application 308 is currently displayed, processing proceeds to S1504. In S1504, the application display manager 305 refers to the application list 607, and determines whether or not an application not requiring authentication exists among applications of screens specified to be displayed in the future.

In a case where it is determined in S1504 that the application not requiring authentication exists, processing proceeds to S1505. In S1505, the application display manager 305 determines whether or not the system event is a timer notice notified after elapse of a certain time. In S1505, in a case where it is determined that the system event is the timer notice after elapse of the certain time, processing proceeds to S1506. In S1506, the application display manager 305 displays the presentation screen 1401 on the operation panel 213, and records information of the presentation screen 1401 by the displayed application recording unit 609.

In S1503, in a case where it is determined that the screen of the authentication application 308 is not currently displayed, processing proceeds to S1507. In S1507, the application display manager 305 refers to the displayed application recording unit 609, and determines whether or not the presentation screen 1401 is displayed. In a case where the presentation screen 1401 is displayed, in S1508, the application display manager 305 determines whether or not the system event is the timer notice notified after elapse of the certain time. In a case where it is determined in S1508 that the system event is the timer notice after elapse of the certain time, in S1509, the application display manager 305 displays the screen of the authentication application 308, and records information of the screen of the authentication application 308 by the displayed application recording unit 609.

In a case where it is determined in S1508 that the system event is not the timer notice, processing proceeds to S1510. In S1310, the application display manager 305 determines whether or not the system event is an “OK” key pressing event. In a case where it is determined to be the “OK” key pressing event, the application display manager 305 displays the screen of the authentication application 308 in S1509, and records the information of the screen of the authentication application 308 by the displayed application recording unit 609.

As described above, according to the present embodiment, the application display manager 305 detects that a certain time has elapsed since display of the authentication screen, displays the presentation screen about the operation method on the operation panel 213, and thereby can present the operation method to the user. As a result of this, extra operation of making transition to the application not requiring authentication also becomes unnecessary, and user operability is improved.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-143069, filed Jun. 26, 2012, which is hereby incorporated by reference herein in its entirety.

What is claimed is:

1. An image processing apparatus comprising:
a setting unit configured to set order of displaying respective screens of a plurality of applications on a display component and set information indicating whether or not to perform user authentication for each of the plurality of applications; and
a control unit configured to skip processing of the user authentication to display a screen of a second application on the display component based on the set information and the set order, in a case of starting a first application set so as to perform the user authentication.

2. The image processing apparatus according to claim 1, wherein the screen of the second application is a screen of an application set in the display order to be displayed next to the screen of the first application.

3. The image processing apparatus according to claim 1, wherein the screen of the second application is a screen of an application set in the display order to be displayed first after the screen of the first application is displayed among screens of applications in which user authentication is not set to be performed.

4. The image processing apparatus according to claim 1, comprising:
a unit configured to switch display of the display component to a presentation screen that presents an operation method for skipping processing of user authentication in a case where a certain time has elapsed after display of a screen of an application for the user authentication on the display component; and
a unit configured to switch the display of the display component to the screen of the application for the user authentication in a case where a certain time has elapsed after the display of the presentation screen on the display component.

5. The image processing apparatus according to claim 4, wherein the set information is received by a method in accordance with the operation method presented on the presentation screen.

6. A method executed by an image processing apparatus, wherein the method comprises:
a step of setting, by a setting unit, order of displaying respective screens of a plurality of applications on a display component and set information indicating whether or not to perform user authentication for each of the plurality of applications; and
a step of skipping, by a control unit, processing of the user authentication to display a screen of a second application on the display component based on the set information and the set order, in a case of starting a first application set so as to perform the user authentication.

7. A non-transitory computer readable storage medium storing a program for causing a computer to function as an image processing apparatus, wherein the image processing apparatus comprises:
a setting unit configured to set order of displaying respective screens of a plurality of applications on a display component and set information indicating whether or not to perform user authentication for each of the plurality of applications; and
a control unit configured to skip processing of the user authentication to display a screen of a second application on the display component based on the set information and the set order, in a case of starting a first application set so as to perform the user authentication.
